(19) United States
(12) Patent Application Publication
(10) Pub. No.: US 2013/0138455 A1
(43) Pub. Date: May 30, 2013

(54) AUTOMATED INTEGRATED SYSTEM, METHOD AND PLATFORM FOR HEALTHCARE SERVICES

(71) Applicant: Pawan Saharan, Maharashtra (IN)

(72) Inventor: Pawan Saharan, Maharashtra (IN)

(21) Appl. No.: 13/816,064

(22) PCT Filed: Aug. 9, 2011
(86) PCT No.: PCT/IN2011/000522

§ 371 Date: Feb. 8, 2013

(30) Foreign Application Priority Data
Aug. 11, 2010 (IN) 1781/MUM/2010

(51) Int. Cl. G06F 19/00

(52) U.S. Cl. CPC G06F 19/3425
USPC 705/2

(57) ABSTRACT

The present invention relates to a web based integrated informatics system for healthcare services. In one embodiment, this is accomplished by one or more client device, one or more server including at least one control logic module, one or more databases for maintaining a plurality of health care related information for users and one or more communication network integrating the server, the client device and the database to communicate with each other, wherein the system is configured to receive information or request sent by one or more client devices, where the received information/s or request/s are processed by the control logic of the server, where the control logic processes the information or request based on the business and data logics with the all available databases, the processed request is integrated with relevant healthcare information or services and received by the client device.

### FIELD OF THE INVENTION

The present invention relates to medical science technology. More specifically, the present invention relates to a network based medical informatics system for healthcare services aiding clinical trials and new drug discovery.

### BACKGROUND OF THE INVENTION

Medical sciences are continuously making advances like new medications and treatment are developed and introduced almost everyday. Medical science is the art and science of curing and treating diseases, whereas doctor accesses a patient and prescribes a course of treatment by either giving the patient medicine or by way of surgery.

In most conventional case, when a patient is unwell, he/she would visit a doctor or hospital. However, with advent in technology a new application of clinical medicine was developed called telemedicine, where the patient could receive health care without visiting the doctor by way of communicating over the phone or internet. This also made it possible to provide health care in rural areas.

With further advent in technology a new field called medical informatics evolved. A medical informatics system is the intersection of computer science and health care. This system focuses on acquiring patient data, processes it and stores it in computers. Physicians and health administrators can efficiently retrieve this data as per requirement and also use it for clinical research and new drug discovery. It is applied to the areas of nursing, clinical care, dentistry, pharmacy, public health and (bio) medical research.

Today's healthcare communication systems are hindered by several drawbacks. Medical information is not shared among professionals quickly enough to meet the need to provide rapid and universal development and distribution of medical knowledge. Present medical knowledge databases merely accumulate independent research work.

Analyzing this large body of work so as to produce new and efficient medical treatment protocols often requires laborious human work. Such human interface and interpretation is a required link in transforming the stored accumulated clinical and research data into knowledge available to the professional medical community at large. Human labor tends to increase the cost as well as to decrease the reliability of the knowledge distributed. Present medical delivery systems rely on having the patient consult a medical professional for diagnosis and therapy. The professional holds the relevant medical information by virtue of his own education and experience. As a result, significant costs in time and resources are spent on the education and specialization of relatively few professionals who need to respond to the healthcare demands of a large number of patients. This “bottleneck” is a major reason for the ever-increasing cost of medical care in modern developed economies.

Further, in medical informatics brings together people from diverse backgrounds and levels of medical knowledge, but since medical informatics system are implemented in hospitals and other health centre's independently due to same there is no information sharing between the hospitals.

For the reasons stated above, which will become apparent to those skilled in the art upon reading and understanding the specification, there is a need in the art for an automated integrated system, method and platform which helps in managing the total health care services with the inclusion of drug discovery and clinical trials.

### BRIEF DESCRIPTION OF THE INVENTION

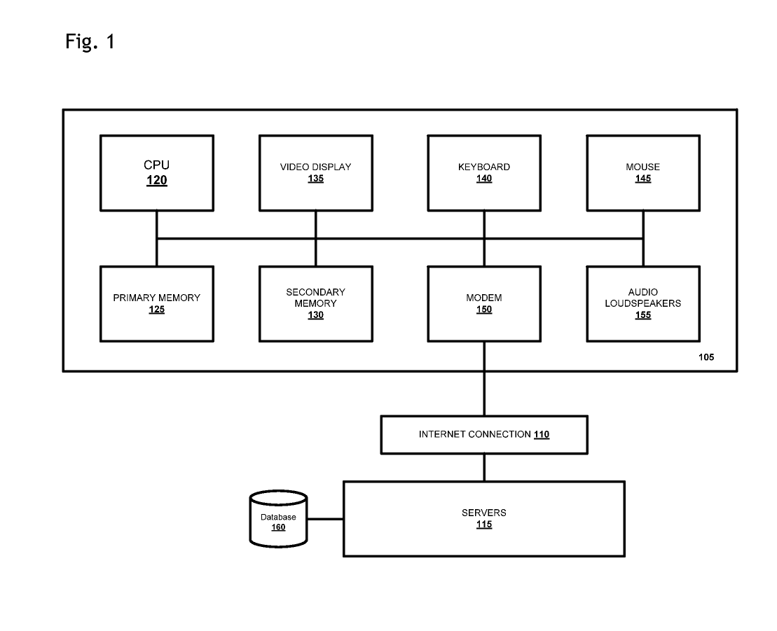

FIG. 1 is a general block diagram illustrating client-server architecture that is suitable for practicing the embodiment of the present invention.

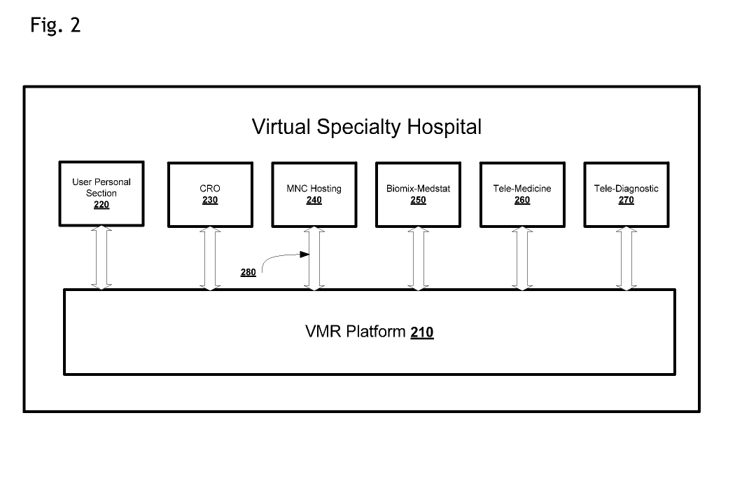

FIG. 2 illustrates a functional block diagram of a virtual specialty hospital system according to one embodiment of the present invention.

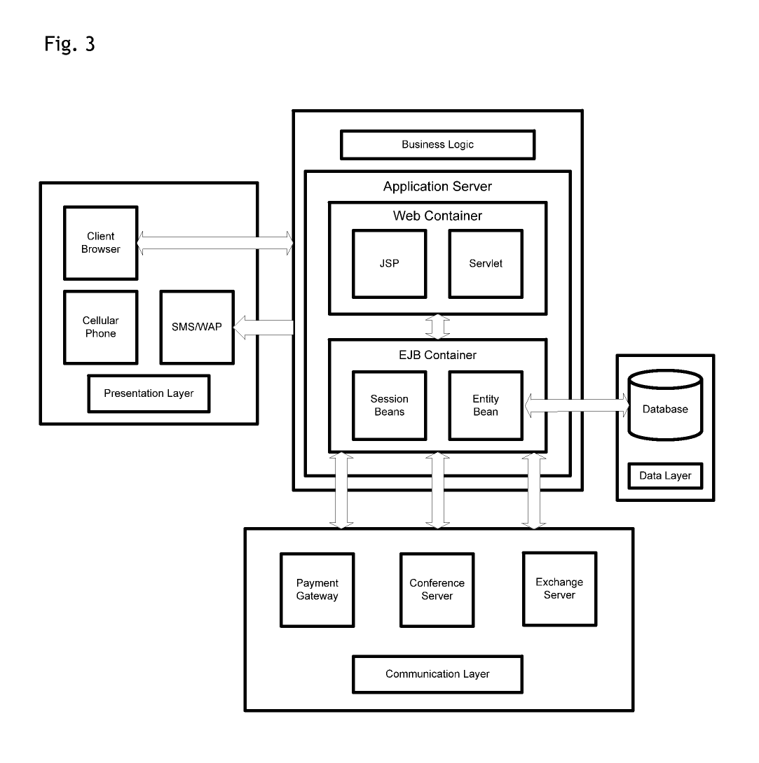

FIG. 3 illustrates a high-level architecture of a virtual specialty hospital system according to one embodiment of the present invention.

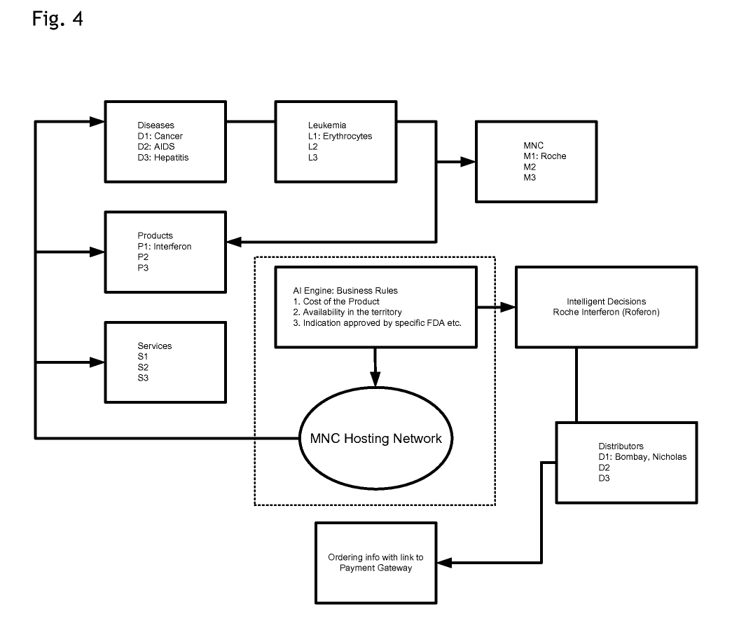

FIG. 4 shows an operation of virtual specialty hospital system which provides hosting service for all healthcare, pharma, diagnostic, insurance and other MNC hosting service network.

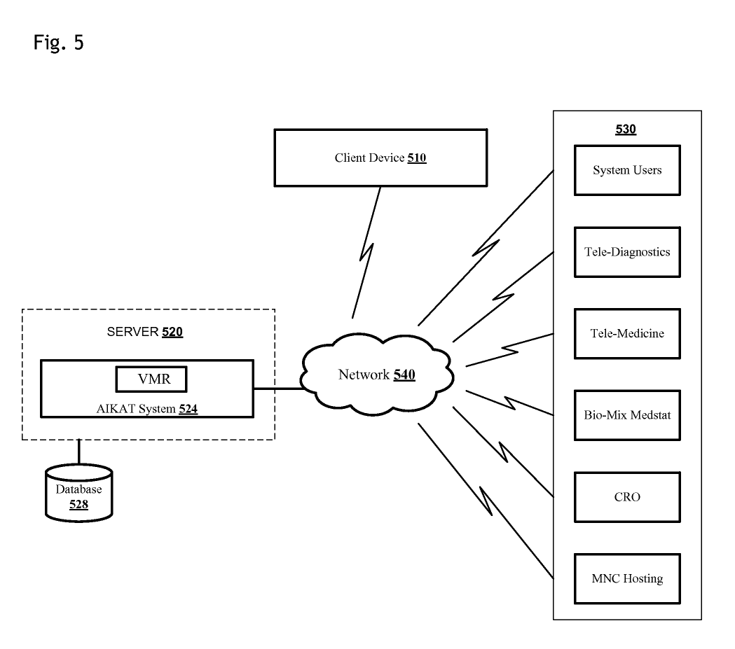

FIG. 5 shows an integrated web based interface system for managing the total health care services according to one embodiment of the invention.

### DETAIL DESCRIPTION OF THE INVENTION

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention.

The leading digit(s) of reference numbers appearing in the Figures generally corresponds to the Figure number in which that component is first introduced, such that the same reference number is used throughout to refer to an identical component which appears in multiple Figures. The same reference number or label may refer to signals and connections, and the actual meaning will be clear from its use in the context of the description.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in demonstrative embodiments,” “in some embodiment,” “in other embodiments,” or similar language throughout this specification do not necessarily all refer to the same group of embodiments and the described features, structures, or characteristics may be combined in any suitable manner in one or more embodiments.

FIG. 1 is a general block diagram illustrating client-server architecture that is suitable for practicing the embodiment of the present invention. Within this environment, client computer 105 is connected with servers 155 via Internet connection 110. The servers 115 are coupled to a search engine database 160. The role of the servers 115 will be discussed in more detail below. The client computer 105 includes a central processing unit (CPU) 120 that has access to a primary memory 125 and a secondary memory 130. The primary memory includes a copy of a web browser (not shown in figure) for purposes of the discussion below, it is assumed that the web browser is the Microsoft Internet Explorer web browser produced by Microsoft Corporation of Redmond, Wash. The primary memory also holds a copy of an operating system (not shown in figure), such as the Microsoft® Windows®95 operating system sold by Microsoft Corporation. The primary memory additionally holds a registry (not shown in figure) that holds registered configuration information. The client computer 105 may also include a number of input/output devices, including video display 135, keyboard 140, mouse 145, a modem 150 and audio loudspeakers 155.

Those skilled in the art will appreciate that the computer environment shown in FIG. 1 is intended to be merely illustrative. The present invention may also be practiced in other computing environments. For example, the present invention may be practiced in multiple processor environments wherein the client computer includes multiple processors. Moreover, the client computer need not include all of the input/output devices shown in FIG. 1 and may also include additional input/output devices. Those skilled in the art will appreciate that the present invention may also be practiced with intranets and more generally in distributed environments in which a client computer requires resources from a server computer.

FIG. 2 illustrates a functional block diagram of a virtual specialty hospital system 200 according to one embodiment of the present invention. Virtual Specialty Hospital (VSH) is aimed at providing World's first Virtual R & D and neutral hosting service for all health care, pharmaceutical, bio-technology and diagnostic Multi-national companies. VSH system is a SMS/2.5G wireless features enabled networking platform for the first Virtual Specialty Hospital and has unique features viz. and may include or connected by a link 280, where the system may include Virtual Medical Representative VMR 210, User Personal Section 220, Clinical Research Organization CRO 230, Multi-National Company (MNC) Hosting 240, Biomix-Medstat 250, Tele-medicine 260 and Tele-Diagnostic 270, Emergency/Trauma section with hospital's OT/bed reservation (not shown in figure), PDR based e-pharmacy and rehabilitation center (not shown in figure).

The Virtual Specialty Hospital (VSH) consists of main modules which are explained in detail below.

### 1. VMR Platform

VSH requires a common platform that offers below mentioned services to all users:
A powerful search which allows the user to search for Doctors, Medicines, Hospitals & Specialists.
Chat facility, AudioNideo Conferencing, Web Casting/Seminars
Conducting surveys for market research
Knowledge store wherein a user can view or add knowledge objects depending on his profile
Bulletin Board where news or events will be displayed
Send health alerts to users mailbox and mobile phones
Facilitate users to buy products and services online
Online Payment Facility, Display Advertisements as per the user profile
Maintain Journal club, which will provide latest journals
Administration of the VSH system.
Generation of reports for the marketing effort and sales generated for each MNC Senior Management Personnel

### 2. MNC Hosting

VSH will offer MNCs a private and secure space and the functionalities offered are as follows:
Managing products and services i.e. adding/updating/deleting the info. about products and services
Managing promotions i.e. MNC might want to send promotions in a email or send invitations for a conference or web cast
Generation of reports by MNCs about the benefits and business generated using VSH
Quick Access to research and information

### 3. CRO

Conducting clinical study/trial for pharmaceutical MNCs, VSH will help automating the whole process right from receiving request to delivering the clinical trials report. The functionality offered is as follows:
Manage clinical study/trial project
Create and manage clinical study/trial team
Track project milestones
Send reminders about milestones to the team
Upload final report of clinical study/trial for FDA approval

The CRO module of VSH will enable information gathering for the core clinical study/trial activity that will be performed using the CRO tool (to be built separately).

### 4. Biomix-Medstat

The Biomix-Medstat section will contain documents and presentations related to clinical studies/trials. The functionality offered are as follows:
Upload documents and presentations related to clinical studies/trials
List the documents based on their category
Existing documents and presentations in web will be maintained

### 5. Tele-Medicine

This will help the patients who don't have the required medical facilities in their vicinity. This module captures/manages complete information about patients and their medical treatment details. The functionality offered is as follows:
Create/Manage patient's medical treatment profile
Create/Manage patient's profile
Refer patients to specialists, pathology labs and hospitals
Manage doctor's loyalty points
Create/Manage patient's report details
Manage details of rehabilitation and trauma centers
Manage details of motels/guest houses/lodges

### 6. Tele-Diagnostic

This is mainly to generate patient's reports. The functionality offered is as follows:
Generate patient's reports
Print reports
Send SMS to specialist

### 7. System Users

Pharmaceutical MNCs
Research Institutions and Scientists
Doctors
Super Specialist Doctors (SSDs), GP, Specialist
Pathologist, Radiologist, Diagnostic Centers
Hospitals, Nursing Homes, HMOs
Government Health Agencies
Clinical Research Organizations, Analytical Centers
Drug Distributors, C&FA, Super Distributors
Chemists, Medical Agencies
Rehabilitation and Trauma Centers
Motels, Pharmaceutical Equipment Supplier/Distributor
Guest or any other users
Mobile Service Providers

FIG. 3 illustrates a high-level architecture of a virtual specialty hospital system according to one embodiment of the present invention. The Virtual Specialty Hospital applications are designed on a three-tier model comprising of Presentation Layer, Business Logic Layer, Data Layer and Communication Layer.

### Presentation Layer

The presentation layer is a polymorphic interface, which gives the user access to the system. This layer presents data to the user, permits data manipulation and data entry. The presentation will be implemented using JSP and Servlets, which will be running in the web container of the application server. The user interaction with the system will be through JSP pages dynamically producing HTML content. Any information or request from the user will be forwarded to the middleware (EJB Components) for processing and/or storing in the database.

### Business Logic Layer

The business logic layer consists of business and data rules. Also referred to as the middle-tier, it helps in solving mission-critical business problems and achieving major productivity advantages. The components that make up this layer can exist on a server machine, to assist in resource sharing. These components can be used to enforce business and data rules. Because these middle-tier components are not tied to a specific client, they can be used by all applications and can be moved to different locations, as response time and other rules require. EJB Components will form the middle layer of the system that will handle the business logic and database interactions.

All the business logic components (Enterprise Java Beans) will be hosted on the application server. This layer will also interact with all the external components used in the system.

### Database Layer

This layer contains data and other database objects like stored procedures etc. that is manipulated by the system. All database interactions will be through the middle tier i.e. the EJB components. The presentation layer will interact with the database through the business layer components.

### Communication Layer

Communication layer will have third party components that will be customized and integrated with the system to add required functionality to it. The system will interact with a number of different components as shown in the figure.

### E-Mail Server

This component will be integrated to set up e-mail, scheduling, contacts, and collaboration. The e-mail server will provide a platform for sending and receiving emails. Programs will be built on top of e-mail server to implement web mail (accessible through a browser).

FIG. 4 shows an operation of virtual specialty hospital system which provides hosting service for all healthcare, pharma, diagnostic, insurance and other MNC hosting service network.

In an example embodiment of the present invention, the hosting network will have a standardized form for all the companies to list their products and services which can be integrated/linked to the database via Artificial Intelligence engine. It will have all the information on the company that it would like to share in a secured database of its own which can be updated only by the authorized personnel.

The Hosting database will be stored in a structured pattern based on business rules/logic and will preempt MVR to offer not only customer specific services but will also assist him in deciding the right choice of a product for his/her needs. For Example: If a Doctor is looking for a particular drug for a particular disease, he/she should be able to get a feedback not only on the availability of the product, its online ordering via a distributor located in that doctor's territory that can be ascertained by the doctor's ID and other location information that he/she may feed in the request form, but will also help the doctor by presuming the availability of the drug based on the paying capacity/other business rules of doctors/patients.

Customer will be able to select a specific product for a specific disease based on the business rules by MNC/Biomix. The disease, products and services will be inter linked via Al engine which will help select a particular brand based on the cost or other business logic by the customer at a particular given time as depicted in the figure.

The neutral platform will enable companies from all over the q2world to host on a single platform VSH. VSH will have hosting of all major pharma, diagnostic, Healthcare, Insurance, Telecommunication companies.

FIG. 5 shows an integrated web based interface system 500 for managing the total health care services according to one embodiment of the invention. The web based interface system includes one or more client device 510, one or more servers 520 including an AIKAT (Artificial Intelligence Knowledge Acquisition Tool) module 524 which may have Virtual Medical Representative (VMR) unit, one or more databases 530 network and one or more communication network 540. The AIKAT module 524 of the server is basically a search engine which provides quick and efficient health care services to all the modules including but not limited to tele-diagnostics modules, tele-medicine modules, clinical research organization modules, Multi-National Company hosting modules etc. The AIKAT module or system of the server may have a database 528. The web based interface system further includes a one or more active modules and their databases (not shown in figures) including system users, tele-diagnostics modules, tele-medicine modules, Bio-mix medstat modules, clinical research organization modules, Multi-national Company hosting modules etc.

The web based interface system not only network all the super specialist and specialist doctors with the general practioners and hospitals but will also take the tele-medicines and tele-diagnostics even to the most remote corner of the country via the fastest and most cost effective route of the world in near future. AIKAT system also used for the discovery of new products in the entire spectrum of life sciences including pharmaceuticals and agriculture biotechnology.

The web based interface system uses a specific protocol which is designed to allow scientists/doctors from diverse fields, with no computational training, to accurately articulate their experimental findings into a coherent, standardized information language.

The web based interface system has formatted critical genetic information especially for Cancer and AIDS. The interface is especially designed for coherently representing a range of disparate information types. Experimental findings encoded into this system may be accessed and queried with exceptional semantic precision, helping to address one of the major challenges to molecular science in the post-genome era. This aggregate knowledge base also comprises a platform for developing increasingly sophisticated computational approaches to biological discovery.

Any general approach to translation of biological information obviously requires great expressiveness and flexibility. The present web based interface system relies on general models of experimental design that intuitively accommodate a considerable proportion of the results found in scientific literature. Such formalized models enable any biological scientist to deconstruct the semantics of a given piece of information into its constituent components.

Once properly deconstructed, these components (and thereby the corresponding biological finding) can be easily entered into the knowledge base using a user-friendly web based interface.

In addition, the user friendly web based interface system that clinical oncology scientists/doctors use to enter functional biological data into knowledge base, a frame based knowledge representation system. This aggregate knowledge base also comprises a platform for developing increasingly sophisticated computational approaches to oncology in new product discovery.

Moreover, the web based interface system will enhance the discovery of new products in the entire spectrum of life sciences. The web based interface system not only helps to discover new molecules but will also analyze and recommend supplementary therapies for the existing/products in the pipeline. This model can be applied to other therapeutic areas like cardiology, diabetes etc. using a different focused database.

The web based interface system having AIKAT has one or more application modules including (1) Virtual Medical Representative (VMR) which interacts with multi-national companies, doctors and hospitals for clinical studies, e-commerce etc, (2) Clinical Research Org (CRO) which conducts clinical studies and trials based on FDA requirement and crunches the time period in the total drug discovery and launch of new molecules/products (devices), (3) Multi-National Hosting (MNC) which conducts basic new drug research, their clinical studies and trials along with the marketing of their products and services (drugs, equipment, diagnostics and related services) to doctors and hospitals via VMR.

In addition, the web interface system also capable of conducting Virtual Research & Development from the basic Drug Discovery right from identification of lead molecule stage for a specific first line therapy for a specific disease. Artificial Intelligence based highly interactive engine will maneuver frame-based biological events in a very high number crunching software to bring out a desired result which not only can be tested in the laboratory, but also has a large pool of references from the peer-reviewed first rate scientific journals based on real time online intelligent search.

The web based interface system provides a unique platform which enables doctors, scientists, pharmaceutical/healthcare companies to form an intelligent network to host over a common shared world standard of treatment and prevention of life threatening diseases. The system basically integrates total healthcare services which aids R & D for drug discovery and clinical trials.

In an example embodiment of the invention, the web based interface system allows scientists doctors from diverse fields with no computational training to accurately articulate their experimental findings into the system wherein the information entered will be encoded into a frame-based knowledge representation, thereby standardizing the information in the system. These experimental finding encoded into the system may be accessed and queried with exceptional semantic precision. This aggregate knowledge base also comprises a platform for developing increasingly sophisticated computational approaches to biological discovery. The system further comprises of considerable proportion of the results found in scientific literature, wherein the scientific literature is encoded into a standardized formats.

In another example embodiment of the invention, the web based interface system comprises of medical discovery information which is used for the discovery of new products in the entire spectrum of life sciences (both pharmaceuticals and agriculture biotechnology). It not only helps to discover new molecules but will also analyze and recommend supplementary therapy for the existing products. The same model will be applied to other therapeutic areas of medical science through a different focused database.

In an another example embodiment of the invention, the web based interface system capable of providing services to specialist doctors, hospitals through an intelligent network which will track information from the backend database and come out with an auto response form most of the requests made by doctors, hospitals. In case if system is unable to retrieve any information, the system automatically divert the communication to the responsible person at pharmaceutical multi national company. This system have highly secured email boxes containing all the information that a customer may request at any given time and hence accumulating more and more information. In addition, the system also assists in clinical study/trial by automating the whole process right from receiving request to delivering the clinical trial reports. It basically enables information gathering for the core clinical study/trial activity.

In another example embodiment of the invention, the web based interface system is coupled with tele-medicine and tele-diagnostic modules for preventing, diagnostic consulting with second opinion from super specialist doctors. The concept behind linking the system and modules involves incorporating relevant health based information from authentic sources, reviewing modalities of diagnosis, treatment and targeting areas of deficit where both doctors and laymen are at a loss to utilize this knowledge constructively. The availability of such super specialist doctors and leading specialty laboratories (i.e. diagnostic centers) is restricted to large metro cities due to the huge investment that has gone in the healthcare setup in such large metros world over where super specialist doctors are attached.

In addition of the above, the system also provides a second opinion consulting and online transfer of patient records, new diagnostic and treatment profiles across the world. As an example, the disclosure explains tele-medicine/tele-diagnostics which will have links to all super specialist doctors, general physician doctors, small and major (tertiary care) hospitals, nursing homes and health management organizations. These links have to be built around the artificial intelligence engine which will have the intelligence of location in addition to functioning of a hospital where a patient walks in to register a health complaint followed by diagnosis, consultation and treatment/operation/rehabilitation.

### Tele-Medicine

Patient goes to a doctor through the web based interface system in a district town with a health problem:
Name, address & other particulars
Medical history—with drop down lists
Physical examination—with drop down lists

General physician doctor goes to a specialist doctor on the web based interface system in a district town with a health problem:
Medical history—pull down and click
Physical examination—pull downs and click

Option for the doctor (different referrals)
Pathology tests can be performed by the doctor or his assistant in his own clinic using the diagnostic kits-urine, blood sugar etc.
Pathology tests to be performed outside: Doctor collects the sample, wherever possible and sends to the pathology lab or the patient takes it to the lab.
   Blood—different tests in drop down lists
   Urine—stools and others
Radiology—X-ray, CT scan, MRI etc
Cardiology—ECG
Urology
The doctor can click the name of any of the above, most convenient to the patient, close to his/her residence, in the same or nearby town or if not available in metropolitan city, and the tests that he would like to see.
Final click prints out the referral notes for the specialist—pathology, radiology, diagnosis and the line of treatment (medicines-dose-to be taken, it should also be possible to set up the appointment data, time etc). A copy of the referral note also goes electronically to the specialist, along the doctor's observations (if required). At the end of the day, connect to Internet and transfer through email.
Return path: Reports of the test and specialist come to the doctor through email and goes to the patient's e-file. Diagnosis, line of treatment: suggested medicines, dose—All of these can be as drop down lists.
Referral to a super specialist:
   Case History
   All reports and slides for expert views about malignancy
   Present diagnosis
   Treatment underway
Can be collated and sent to the super specialist electronically or handed over to the patient on a floppy.
Tele Medicines: Advantages for District Level Specialists
The main advantage beneficiaries would be the specialists (later General Physician) in district level towns through:
   Better access to information on available diagnostics, drug specialists/hospitals in the metropolitan cities, cost of surgical intervention: Hospital/Nursing home charge (For example: Dr. X at Hinduja Hospital carries out such operation, charges would be approximately Rs. 50,000/−, plus a minimum of 10-day stay in Hinduja Hospital for which the rates are: for general ward, semi private ward, private ward, deluxe ward. Relatives cannot stay with the patient in the hospital. The nearby hotels are following and their charges are Rs . . . /day. The total cost is expected to be Rs. 1.25 lakhs)
Reduced paper work, and hence more time for the patients or more patients.
Continuing knowledge up gradation.

Advantages for specialist in Metropolitan cities:
Specialists and super specialists in metropolitan cities would benefit, besides the above, through access to most recent information from Europe and US about new diagnostics, drugs, drug delivery systems, recent research, participation in clinical trials for drugs already approved in US, Europe & Japan.
Quick availability of “not so common drugs”
Referrals to specialists abroad
Increased referrals from the district level

Advantaged for Patients
Information
Saving of time, travel and other hassles
Quick information on the cost of treatment—can he/she afford to pay for it
More time to arrange for money
Ultimately save some lives that are otherwise lost due to non-availability of proper medical aid

Advantages for pharma companies
Direct electronic distribution of information about their products/diagnostics/drugs to doctors
Virtual MR
Doctor may not agree to meet the MR but the company product would always appear
Increased sales
Advertising trends are changing and net advertising is also increasing
Increased sale of expensive, “not common drugs” directly sold to patients

Tele-medicine and Tele-diagnostics module can also run together, independent from the rest of virtual specialty hospital (VSH) but will have full access to the database, VMR and MNC hosting on VSH as described above. It will be integral part of VSH Platform and will have its own artificial intelligence based on the super specialist doctors, general physicians, hospitals, diagnostic center database which will be entered into a standard format. It will have payment gateway for patients by way of B2C network, and between doctors (D2D).

### Advantages

1. Reduced cost and effort through automation of analytic and reporting activities
2. AIKAT VMR Engine is built on OMG model driven architecture adhering to layered modular architecture
3. Facilitate plug & play of components, address seamless data transfer through APIs
4. One common platform for one-and-all related to Medical World built on the highest security available
5. Powerful Al based Search Engine
6. Platform agnostic modeling in visual format
7. Role based activities based on proprietary rule engine
8. Capable of generating a wide variety of Reports and Statistics

The present disclosure may be implemented with a variety of combination of hardware and software. If implemented as a computer-implemented apparatus, the present disclosure is implemented using means for performing all of the steps and functions described above.

The present disclosure can be included in an article of manufacture (e.g., one or more computer program products) having, for instance, computer usable media. The media has embodied therein, for instance, computer readable program code means for providing and facilitating the mechanisms of the present invention. The article of manufacture can be included as part of a computer system or sold separately.

FIGS. 1-5 are merely representational and are not drawn to scale. Certain portions thereof may be exaggerated, while others may be minimized. FIGS. 1-5 illustrate various embodiments of the disclosed invention that can be understood and appropriately carried out by those of ordinary skill in the art.

In the foregoing detailed description of embodiments of the invention, various features are grouped together in a single embodiment for the purpose of streamlining the disclosure.

1. A web based integrated informatics system for healthcare services comprising:
at least one client device including at least one interactive user interface module to provide access to the system, wherein the interactive user interface module allows the user to interact with the system by way of providing or searching health related information or services as per user's requirements;
at least one server including at least one control logic module, wherein the control logic module assists and/or suggests a health care services based on the user's requirement;
a plurality of databases for maintaining a plurality of health care related information for users, wherein the users including one or more health care experts; and
a communication network integrating the server, the client device and the database to communicate with each other;
wherein the system is configured to receive information or request sent by one or more client devices, where the received information/s or request/s are processed by the control logic of the server, where the control logic processes the information or request based on the business and data logics with the all available databases, the processed request is integrated with relevant healthcare information or services and received by the client device.

2. The web based integrated informatics system of claim 1, wherein the server is coupled one or more active modules, wherein the user interface module allows the user to enter functional biological data into database for developing increasingly sophisticated computational approaches to virtual medical research for a new product discovery and also allows to analyze and recommend supplementary therapies for the existing products or products in the pipeline.

3. The web based integrated informatics system of claim 1, wherein the server is coupled to one or more active modules including (1) Virtual Medical Representative (VMR) which interacts with multi-national companies, doctors and hospitals for clinical studies, e-commerce etc, (2) Clinical Research Org (CRO) which conducts clinical studies and trials based on FDA requirement and crunches the time period in the total drug discovery and launch of new molecules,products,devices, (3) Multi-National Hosting (MNC) which conducts basic new drug research, their clinical studies and trials along with the marketing of their products and services (drugs, equipment, diagnostics and related services) to doctors and hospitals via VMR.

4. The web based integrated informatics system of claim 1, wherein the server is configured for conducting Virtual Research & Development from the basic Drug Discovery right from identification of lead molecule stage for a specific first line therapy for a specific disease and also to bring out a desired result which not only can be tested in the laboratory, but also has a large pool of references from the peer-reviewed first rate scientific journals based on real time online intelligent search.

5. The web based integrated informatics system of claim 1, wherein the server is configured to enable doctors, scientists, pharmaceutical/healthcare companies to form an intelligent network to host over a common shared world standard of treatment and prevention of life threatening diseases, wherein the system integrates total healthcare services which aids R & D for drug discovery and clinical trials.

6. The web based integrated informatics system of claim 1, wherein the server is further coupled to provide services to specialist doctors, hospitals through the network which will track information from the backend database and come out with an auto response form most of the requests made by doctors, hospitals and also capable of diverting the communication to the responsible person at any multinational company in order to provide answers to customer request at any given time and thereby accumulating more and more information

7. The web based integrated informatics system of claim 1, further coupled to tele-medicine and tele-diagnostic modules for, diagnostic consulting with second opinion from super specialist doctors.

8. The web based integrated informatics system of claim 1 provides a opinion over consulting and online transfer of patient records, new diagnostic and treatment profiles across the world.

9. The web based integrated informatics system of claim 1, wherein the database includes drug related information, health-expert information, case histories, drug-related information, disease related information, clinical study records, medical discovery records, experimental findings and the like.

10. The web based integrated informatics system substantially as herein described with reference to the above mentioned description and the accompanying drawings.
